(19) United States
(12) Patent Application Publication
(10) Pub. No.: US 2016/0307509 A1
(43) Pub. Date: Oct. 20, 2016

(54) AMOLED PIXEL DRIVING CIRCUIT

(71) Applicant: Shenzhen China Star Optoelectronics Technology Co. Ltd., Shenzhen City (CN)

(72) Inventor: Chenglei NIE, Shenzhen City (CN)

(21) Appl. No.: 14/655,736

(22) PCT Filed: Apr. 1, 2015
(86) PCT No.: PCT/CN2015/075686

§ 371 Date: Jun. 26, 2015

(30) Foreign Application Priority Data
Feb. 3, 2015 (CN) 201510059889.5

(51) Int. Cl. G09G 3/3258; G09G 3/3291; G09G 3/3266

(52) U.S. Cl. CPC G09G 3/3258; G09G 3/3266; G09G 3/3291; G09G 2320/0233; G09G 2300/043; G09G 2300/0819; G09G 2310/0289; G09G 2320/0626

(57) ABSTRACT

The AMOLED pixel driving circuit provided by the present invention, by adding the thin film transistor (M2) controlled by the irradiance control signal (EM) between the organic light emitting diode (D1) and the direct current power supply voltage (VDD) or by utilizing the alternating current power supply voltage (VDD) to control whether the organic light emitting diode (D1) emits light or not to set the irradiance control signal (EM) or the alternating current power supply voltage (VDD) to provide high voltage level only in the drive stage and to provide low voltage level in the rest stages, makes the OLED to be in off state in the irradiance unnecessary period and stops the OLED emitting light in the irradiance unnecessary period. Thus, the issue that the unnecessary irradiance of the organic light emitting diode occurs during the process of compensating the drift of the threshold voltage of the drive thin film transistor in the AMOLED pixel driving circuit according to prior art can be solved to extend the lifetime of the OLED and optimize the actual display effect of the panel.

### FIELD OF THE INVENTION

The present invention relates to a display technology field, and more particularly to an AMOLED pixel driving circuit.

### BACKGROUND OF THE INVENTION

The Organic Light Emitting Display (OLED) possesses many outstanding properties of self-illumination, low driving voltage, high luminescence efficiency, short response time, high clarity and contrast, near 180° view angle, wide range of working temperature, applicability of flexible display and large scale full color display. The OLED is considered as the most potential display device.

The OLED can be categorized into two major types according to the driving methods, which are the Passive Matrix OLED (PMOLED) and the Active Matrix OLED (AMOLED), i.e. two types of the direct addressing and the Thin Film Transistor (TFT) matrix addressing. The AMOLED comprises pixels arranged in array and belongs to active display type, which has high lighting efficiency and is generally utilized for the large scale display devices of high resolution. The AMOLED is a current driving element. When the electrical current flows through the organic light emitting diode, the organic light emitting diode emits light, and the brightness is determined according to the current flowing through the organic light emitting diode itself. In the AMOLED driving circuit, the threshold voltage of the drive thin film transistor will drift along with the working times. Thus, it results in that the luminescence of the OLED is unstable. Therefore, the pixel driving circuit which can compensate the drift of the threshold voltage of the drive thin film transistor is required to be utilized.

FIG. 1 shows an AMOLED pixel circuit according to prior art, comprising a second switch thin film transistor SW2, and a gate thereof is electrically coupled to an nth second scan control signal gate2(n), and a source is electrically coupled to a data signal data, and a drain is electrically coupled to a drain of a mirror thin film transistor MR and one end of the second capacitor Cst2; the mirror thin film transistor MR, and a gate thereof is electrically coupled to a drain of a drive thin film transistor DR via a first node D, and a source is electrically coupled to a source of a first switch thin film transistor SW1, and the drain is electrically coupled to the source of the second switch thin film transistor SW2 and the one end of the second capacitor Cst2; the first switch thin film transistor SW1, and a gate thereof is electrically coupled to an nth first scan control signal gate1(n), and a source is electrically coupled to the source of the mirror thin film transistor MR, and a drain is electrically coupled to the first node D; a pre-charge thin film transistor PC, and both a gate and a drain thereof are electrically coupled to an n−1th second scan control signal Gate2(n−1), and a source is electrically coupled to the first node D; the drive thin film transistor DR, and a gate thereof is electrically coupled to the gate of the mirror thin film transistor MR via the first node D, and a source is electrically coupled to the ground GND, and a drain is electrically coupled to an cathode of the organic light emitting diode OLED; one end of a first capacitor Cst1 is electrically coupled to the first node D, and the other end is electrically coupled to the ground GND; one end of a second capacitor Cst2 is electrically coupled to the drain of the second switch thin film transistor SW2 and the drain of the mirror thin film transistor MR, and the other end is electrically coupled to the ground GND; an anode of the organic light emitting diode OLED is electrically coupled to the direct current power supply voltage VDD, and the cathode is electrically coupled to the drain of the drive thin film transistor DR; the direct current power supply voltage VDD provides high voltage level. FIG. 2 is a sequence diagram corresponding to the circuit shown in FIG. 1. The compensation procedure of the circuit sequentially comprises four stages, a Pre-charge stage, a Program stage, a Restore stage and a Drive stage. In the Pre-charge stage, the voltage level of the first node D is raised to be high voltage of the n−1th second scan control signal Gate2(n−1). The drive thin film transistor Dr is activated which results in that the organic light emitting diode OLED is in the irradiance state all the time in the three stages, the Pre-charge stage, the Program stage, and the Restore stage. However, what the panel needs is that the organic light emitting diode OLED emits light only in the drive stage. The irradiance of the organic light emitting diode OLED in the rest three stages is unnecessary irradiance. FIG. 3 is a simulation curve diagram of the drive current of the organic light emitting diode OLED in the aforesaid AMOLED pixel driving circuit. As shown in FIG. 3, the drive current I_{oled} of the organic light emitting diode OLED exists in any of the four stages, which results in that the organic light emitting diode OLED emits light in any of the four stages. However, only the irradiance in the drive stage is normal and necessary. In the three stages before the drive stage, the drive current I_{oled} of the organic light emitting diode OLED is larger and therefore, the brighter irradiance unnecessarily exist. Such unnecessary irradiance will influence the lifetime of the OLED, and meanwhile will affect the actual display effect of the panel, such as the contrast ratio reduction, the appearance of the light leakage phenomenon, etc.

### SUMMARY OF THE INVENTION

An objective of the present invention is to provide an AMOLED pixel driving circuit for solving the issue that the unnecessary irradiance of the organic light emitting diode occurs during the process of compensating the drift of the threshold voltage of the drive thin film transistor in the AMOLED pixel driving circuit according to prior art to make the OLED be in off state in the irradiance unnecessary period for extending the lifetime of the OLED and optimizing the actual display effect of the panel.

For realizing the aforesaid objectives, the present invention provides an AMOLED pixel driving circuit, comprising: a first thin film transistor, a second thin film transistor, a third thin film transistor, a fourth thin film transistor, a fifth thin film transistor, a sixth thin film transistor, a first capacitor, a second capacitor and an organic light emitting diode; the first thin film transistor is a drive thin film transistor, and the fifth thin film transistor is a switch thin film transistor;

a gate of the sixth thin film transistor is electrically coupled to an nth stage second scan control signal, and a source is electrically coupled to a data signal, and a drain is electrically coupled to a drain of the third thin film transistor and one end of the first capacitor;

a gate of the third thin film transistor is electrically coupled to a gate of the fourth thin film transistor via a first node, and a source is electrically coupled to the source of the first thin film transistor, and the drain is electrically coupled to the drain of the sixth thin film transistor and the one end of the first capacitor;

a gate of the first thin film transistor is electrically coupled to an nth stage first scan control signal, and the source is electrically coupled to the source of the third thin film transistor, and a drain is electrically coupled to the first node;

both a gate and a drain of the fifth thin film transistor are electrically coupled to an n−1th stage second scan control signal, and a source is electrically coupled to the first node;

a gate of the second thin film transistor is electrically coupled to an irradiance control signal, and a source is electrically coupled to a direct current power supply voltage, and a drain is electrically coupled to an anode of the organic light emitting diode;

a gate of the fourth thin film transistor is electrically coupled to a first node, and a source is electrically coupled to an earth, and a drain is electrically coupled to a cathode of the organic light emitting diode;

the one end of the first capacitor is electrically coupled to the drain of the sixth thin film transistor and the drain of the third thin film transistor, and the other end is electrically coupled to the earth;

one end of the second capacitor is electrically coupled to the first node, and the other end is electrically coupled to the earth;

the anode of the organic light emitting diode is electrically coupled to the drain of the second thin film transistor, and a cathode is electrically coupled to the drain of the fourth thin film transistor;

the direct current power supply voltage provides direct current high voltage level;

the irradiance control signal provides high, low alternate voltages according to time sequence to control whether the organic light emitting diode emits light or not.

All of the first thin film transistor, the second thin film transistor, the third thin film transistor, the fourth thin film transistor, the fifth thin film transistor and the sixth thin film transistor are Low Temperature Poly-silicon thin film transistors, oxide semiconductor thin film transistors or amorphous silicon thin film transistors.

The nth stage second scan control signal, the nth stage first scan control signal, the n−1th stage second scan control signal and the irradiance control signal are combined with one another, and correspond to a pre-charge stage, a program stage, a restore stage and a drive stage one after another;

the irradiance control signal provides low voltage level in any of the pre-charge stage, the program stage and the restore stage to control the organic light emitting diode not to emit light; and provides high voltage level in the drive stage to control the organic light emitting diode to emit light.

in the pre-charge stage, the nth stage second scan control signal is low voltage level, and the nth stage first scan control signal is low voltage level, and the n−1th stage second scan control signal is high voltage level;

in the program stage, the nth stage second scan control signal is high voltage level, and the nth stage first scan control signal is high voltage level, and the n−1th stage second scan control signal is low voltage level;

in the reset stage, the nth stage second scan control signal is high voltage level, and the nth stage first scan control signal is low voltage level, and the n−1th stage second scan control signal is low voltage level;

in the drive stage, the nth stage second scan control signal is low voltage level, and the nth stage first scan control signal is low voltage level, and the n−1th stage second scan control signal is low voltage level.

in the program stage, the data signal is high voltage level; in the restore stage, the data signal is low voltage level.

The present invention further provides an AMOLED pixel driving circuit, comprising: a first thin film transistor, a third thin film transistor, a fourth thin film transistor, a fifth thin film transistor, a sixth thin film transistor, a first capacitor, a second capacitor and an organic light emitting diode;

a gate of the sixth thin film transistor is electrically coupled to an nth stage second scan control signal, and a source is electrically coupled to a data signal, and a drain is electrically coupled to a drain of the third thin film transistor and one end of the first capacitor;

a gate of the third thin film transistor is electrically coupled to a gate of the fourth thin film transistor via a first node, and a source is electrically coupled to the source of the first thin film transistor, and the drain is electrically coupled to the drain of the sixth thin film transistor and the one end of the first capacitor;

a gate of the first thin film transistor is electrically coupled to an nth stage first scan control signal, and the source is electrically coupled to the source of the third thin film transistor, and a drain is electrically coupled to the first node;

both a gate and a drain of the fifth thin film transistor are electrically coupled to an n−1th stage second scan control signal, and a source is electrically coupled to the first node;

a gate of the fourth thin film transistor is electrically coupled to a first node, and a source is electrically coupled to an earth, and a drain is electrically coupled to a cathode of the organic light emitting diode;

the one end of the first capacitor is electrically coupled to the drain of the sixth thin film transistor and the drain of the third thin film transistor, and the other end is electrically coupled to the earth;

one end of the second capacitor is electrically coupled to the first node, and the other end is electrically coupled to the earth;

the anode of the organic light emitting diode is electrically coupled to an alternating current power supply voltage, and a cathode is electrically coupled to the drain of the fourth thin film transistor;

the alternating current power supply voltage provides high, low alternate voltages according to time sequence to control whether the organic light emitting diode emits light or not.

All of the first thin film transistor, the third thin film transistor, the fourth thin film transistor, the fifth thin film transistor and the sixth thin film transistor are Low Temperature Poly-silicon thin film transistors, oxide semiconductor thin film transistors or amorphous silicon thin film transistors.

The nth stage second scan control signal, the nth stage first scan control signal, the n−1th stage second scan control signal and the alternating current power supply voltage are combined with one another, and correspond to a pre-charge stage, a program stage, a restore stage and a drive stage one after another;

the alternating current power supply voltage provides low voltage level in any of the pre-charge stage, the program stage and the restore stage to control the organic light emitting diode not to emit light; and provides high voltage level in the drive stage to control the organic light emitting diode to emit light.

in the pre-charge stage, the nth stage second scan control signal is low voltage level, and the nth stage first scan control signal is low voltage level, and the n−1th stage second scan control signal is high voltage level;

in the program stage, the nth stage second scan control signal is high voltage level, and the nth stage first scan control signal is high voltage level, and the n−1th stage second scan control signal is low voltage level;

in the reset stage, the nth stage second scan control signal is high voltage level, and the nth stage first scan control signal is low voltage level, and the n−1th stage second scan control signal is low voltage level;

in the drive stage, the nth stage second scan control signal is low voltage level, and the nth stage first scan control signal is low voltage level, and the n−1th stage second scan control signal is low voltage level.

in the program stage, the data signal is high voltage level; in the restore stage, the data signal is low voltage level.

The present invention further provides an AMOLED pixel driving circuit, comprising: a first thin film transistor, a third thin film transistor, a fourth thin film transistor, a fifth thin film transistor, a sixth thin film transistor, a first capacitor, a second capacitor and an organic light emitting diode;

a gate of the sixth thin film transistor is electrically coupled to an nth stage second scan control signal, and a source is electrically coupled to a data signal, and a drain is electrically coupled to a drain of the third thin film transistor and one end of the first capacitor;

a gate of the third thin film transistor is electrically coupled to a gate of the fourth thin film transistor via a first node, and a source is electrically coupled to the source of the first thin film transistor, and the drain is electrically coupled to the drain of the sixth thin film transistor and the one end of the first capacitor;

a gate of the first thin film transistor is electrically coupled to an nth stage first scan control signal, and the source is electrically coupled to the source of the third thin film transistor, and a drain is electrically coupled to the first node;

both a gate and a drain of the fifth thin film transistor are electrically coupled to an n−1th stage second scan control signal, and a source is electrically coupled to the first node;

a gate of the fourth thin film transistor is electrically coupled to a first node, and a source is electrically coupled to an earth, and a drain is electrically coupled to a cathode of the organic light emitting diode;

the one end of the first capacitor is electrically coupled to the drain of the sixth thin film transistor and the drain of the third thin film transistor, and the other end is electrically coupled to the earth;

one end of the second capacitor is electrically coupled to the first node, and the other end is electrically coupled to the earth;

the anode of the organic light emitting diode is electrically coupled to an alternating current power supply voltage, and a cathode is electrically coupled to the drain of the fourth thin film transistor;

the alternating current power supply voltage provides high, low alternate voltages according to time sequence to control whether the organic light emitting diode emits light or not;

wherein all of the first thin film transistor, the third thin film transistor, the fourth thin film transistor, the fifth thin film transistor and the sixth thin film transistor are Low Temperature Poly-silicon thin film transistors, oxide semiconductor thin film transistors or amorphous silicon thin film transistors.

wherein the nth stage second scan control signal, the nth stage first scan control signal, the n−1th stage second scan control signal and the alternating current power supply voltage are combined with one another, and correspond to a pre-charge stage, a program stage, a restore stage and a drive stage one after another;

the alternating current power supply voltage provides low voltage level in any of the pre-charge stage, the program stage and the restore stage to control the organic light emitting diode not to emit light; and provides high voltage level in the drive stage to control the organic light emitting diode to emit light.

The benefits of the present invention are: the AMOLED pixel driving circuit provided by the present invention, by adding the thin film transistor controlled by the irradiance control signal between the organic light emitting diode and the direct current power supply voltage or by utilizing the alternating current power supply voltage to control whether the organic light emitting diode emits light or not to set the irradiance control signal or the alternating current power supply voltage to provide high voltage level only in the drive stage and to provide low voltage level in the rest stages, makes the OLED to be in off state in the irradiance unnecessary period and stops the OLED emitting light in the irradiance unnecessary period. Thus, the issue that the unnecessary irradiance of the organic light emitting diode occurs during the process of compensating the drift of the threshold voltage of the drive thin film transistor in the AMOLED pixel driving circuit according to prior art can be solved to extend the lifetime of the OLED and optimize the actual display effect of the panel.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a circuit diagram of an AMOLED pixel circuit according to prior art;

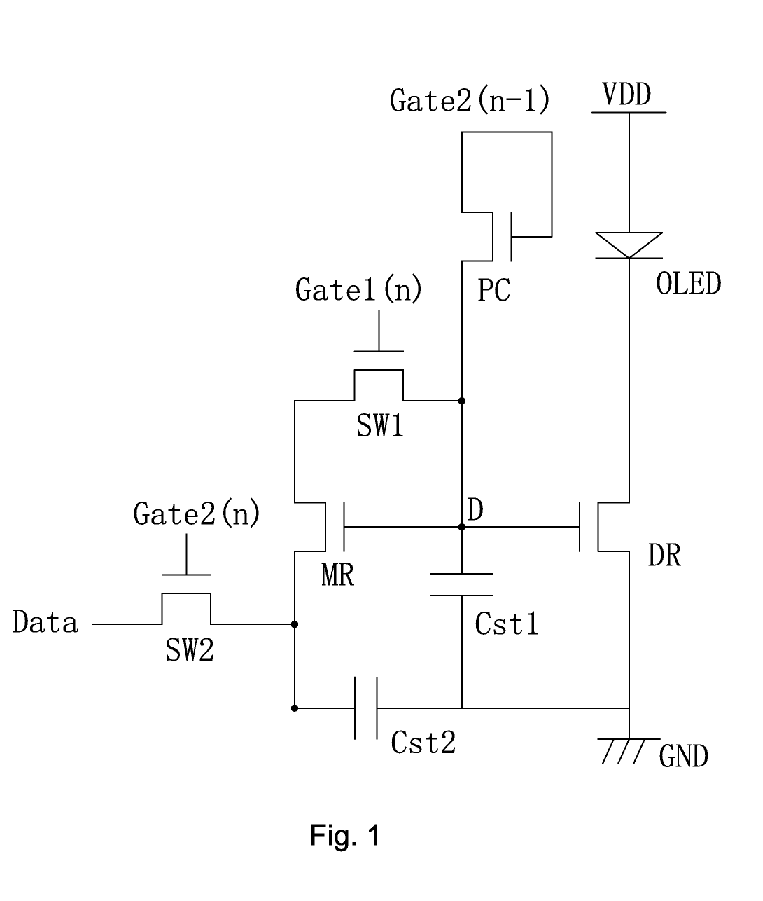

FIG. 2 is a circuit diagram of the first level GOA unit according to the first embodiment shown in FIG. 1;

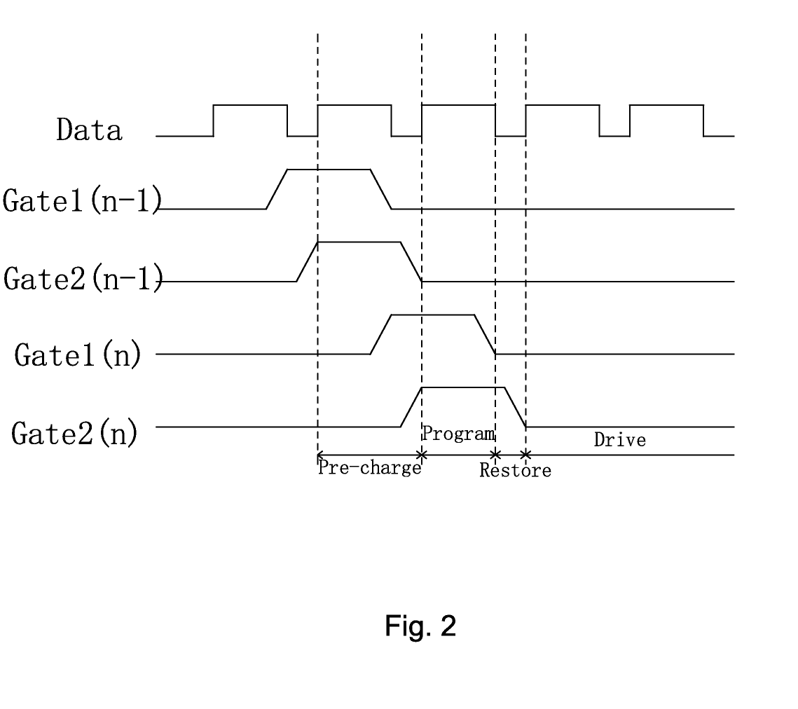

FIG. 3 is a simulation curve diagram of the drive current of the organic light emitting diode in the AMOLED pixel driving circuit shown in FIG. 1;

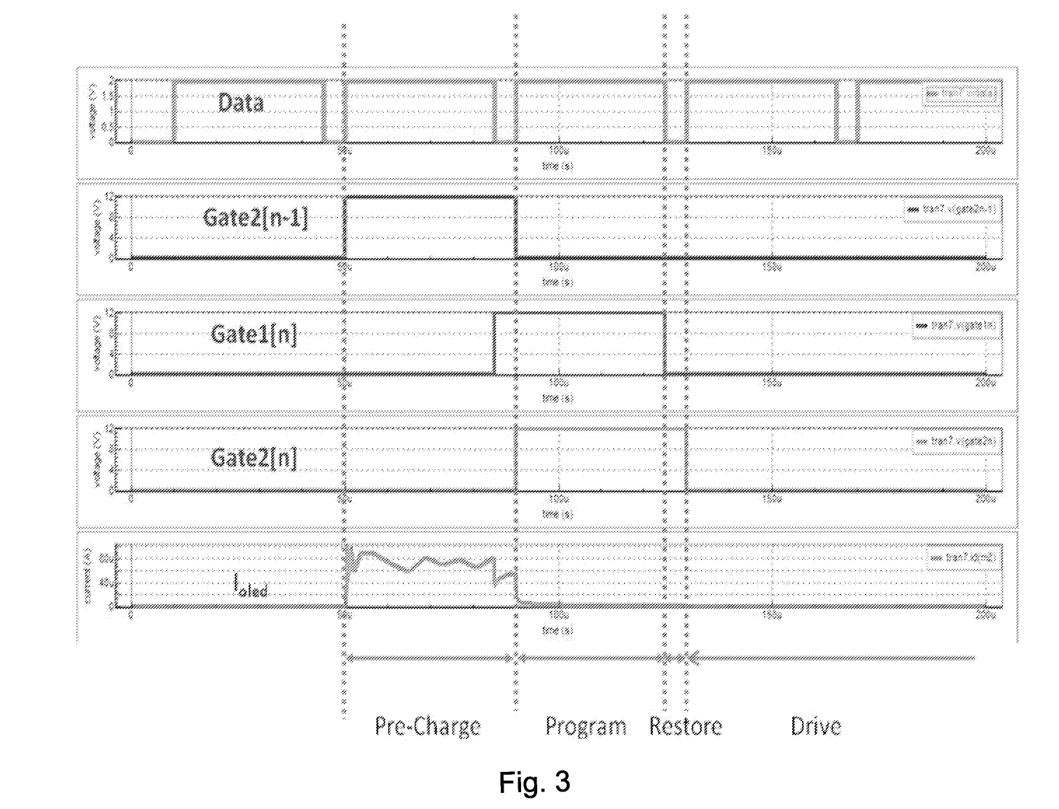

FIG. 4 is a circuit diagram of an AMOLED pixel driving circuit according to the first embodiment of the present invention;

FIG. 5 is a sequence diagram of the AMOLED pixel driving circuit shown in FIG. 4;

FIG. 6 is a simulation curve diagram of the drive current of the organic light emitting diode in the AMOLED pixel driving circuit shown in FIG. 4;

FIG. 7 is a simulation curve comparison diagram of the drive currents of the organic light emitting diodes in the first embodiment of the AMOLED pixel driving circuit according to the present invention and in the AMOLED pixel driving circuit in prior art;

FIG. 8 is a circuit diagram of an AMOLED pixel driving circuit according to the second embodiment of the present invention;

FIG. 9 is a sequence diagram of the AMOLED pixel driving circuit shown in FIG. 8;

FIG. 10 is a simulation curve diagram of the drive current of the organic light emitting diode in the AMOLED pixel driving circuit shown in FIG. 8;

FIG. 11 is a simulation curve comparison diagram of the drive currents of the organic light emitting diodes in the second embodiment of the AMOLED pixel driving circuit according to the present invention and in the AMOLED pixel driving circuit in prior art.

### DETAILED DESCRIPTION OF PREFERRED EMBODIMENTS

For better explaining the technical solution and the effect of the present invention, the present invention will be further described in detail with the accompanying drawings and the specific embodiments.

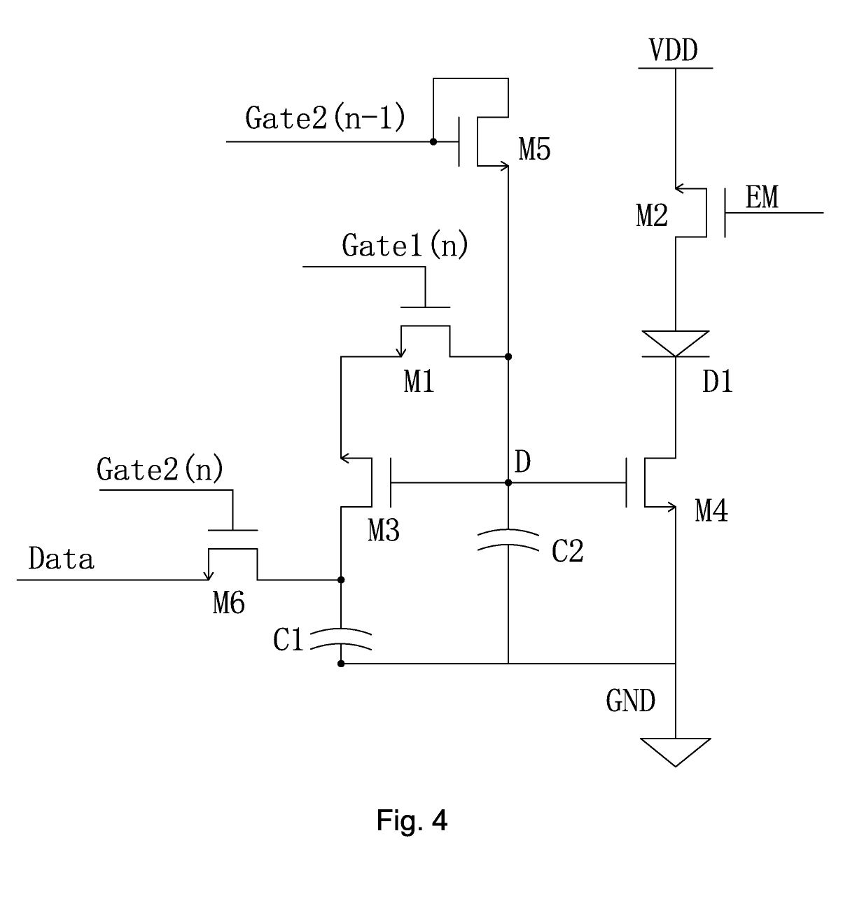

FIG. 4 shows the circuit diagram of the AMOLED pixel driving circuit according to the first embodiment of the present invention, comprising: a first thin film transistor M1, a second thin film transistor M2, a third thin film transistor M3, a fourth thin film transistor M4, a fifth thin film transistor M5, a sixth thin film transistor M6, a first capacitor C1, a second capacitor C2 and an organic light emitting light diode D1. A gate of the sixth thin film transistor M6 is electrically coupled to an nth stage second scan control signal Gate2(n), and a source is electrically coupled to a data signal Data, and a drain is electrically coupled to a drain of the third thin film transistor M3 and one end of the first capacitor C1; a gate of the third thin film transistor M3 is electrically coupled to a gate of the fourth thin film transistor M4 via a first node D, and a source is electrically coupled to the source of the first thin film transistor M1, and the drain is electrically coupled to the drain of the sixth thin film transistor M6 and the one end of the first capacitor C1; a gate of the first thin film transistor M1 is electrically coupled to an nth stage first scan control signal Gate1(n), and the source is electrically coupled to the source of the third thin film transistor M3, and a drain is electrically coupled to the first node D; both a gate and a drain of the fifth thin film transistor M5 are electrically coupled to an n−1th stage second scan control signal Gate2(n−1), and a source is electrically coupled to the first node D; a gate of the second thin film transistor M2 is electrically coupled to an irradiance control signal EM, and a source is electrically coupled to a direct current power supply voltage VDD, and a drain is electrically coupled to an anode of the organic light emitting diode D1; a gate of the fourth thin film transistor M4 is electrically coupled to a first node D, and a source is electrically coupled to an earth terminal GND, and a drain is electrically coupled to a cathode of the organic light emitting diode D1; the one end of the first capacitor C1 is electrically coupled to the drain of the sixth thin film transistor M6 and the drain of the third thin film transistor M3, and the other end is electrically coupled to the earth GND; one end of the second capacitor C2 is electrically coupled to the first node D, and the other end is electrically coupled to the earth GND; the anode of the organic light emitting diode D1 is electrically coupled to the drain of the second thin film transistor M2, and a cathode is electrically coupled to the drain of the fourth thin film transistor M4.

Specifically, all of the first thin film transistor M1, the second thin film transistor M2, the third thin film transistor M3, the fourth thin film transistor M4, the fifth thin film transistor M5 and the sixth thin film transistor M6 are Low Temperature Poly-silicon thin film transistors, oxide semiconductor thin film transistors or amorphous silicon thin film transistors. The sixth thin film transistor M6 is a switch thin film transistor, and the third thin film transistor M3 is a mirror thin film transistor, and the fourth thin film transistor M4 is a drive thin film transistor, and the fifth thin film transistor M5 is a pre-charge thin film transistor, and the second thin film transistor M2 is an irradiance control thin film transistor.

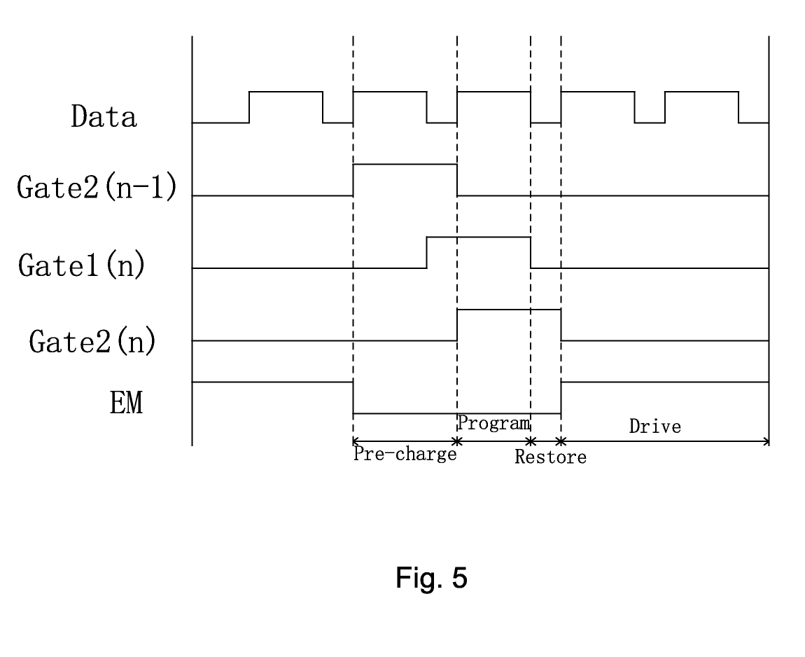

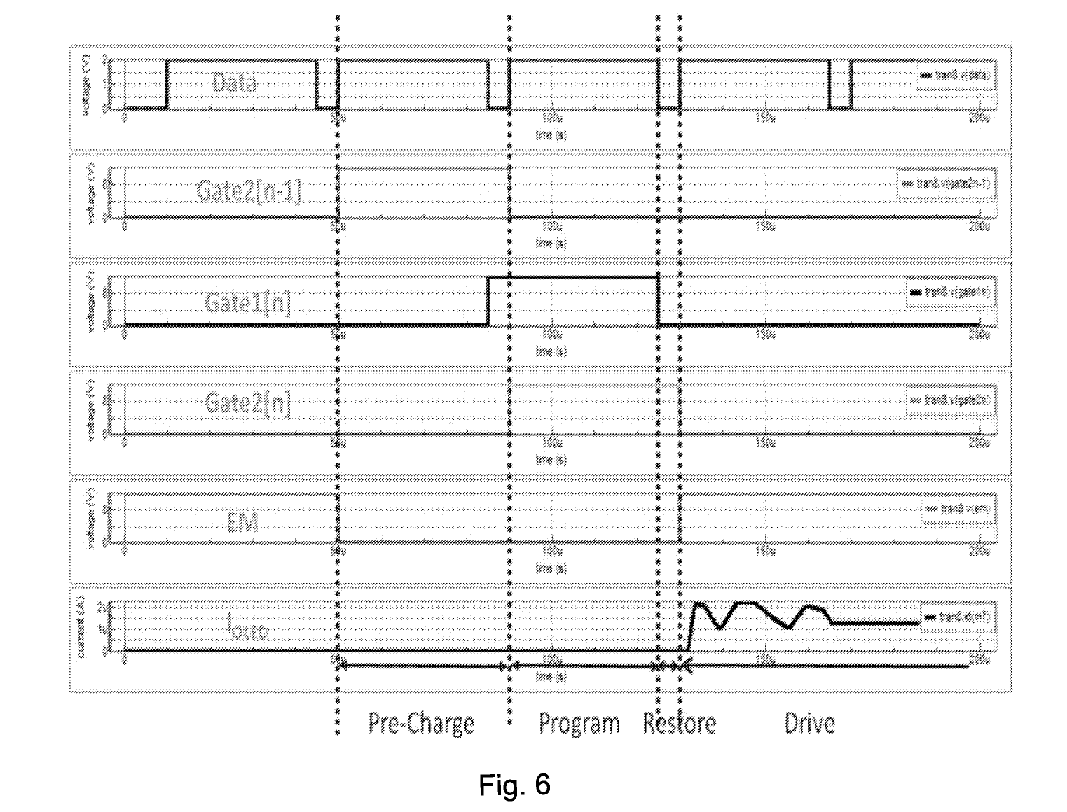

Specifically required for explanation: the direct current power supply voltage VDD provides high voltage level; the irradiance control signal EM provides high, low alternate voltages according to time sequence to control whether the organic light emitting diode D1 emits light or not. Please refer to FIG. 4, FIG. 5, FIG. 6, together. In the first embodiment, the nth stage second scan control signal Gate2(n), the nth stage first scan control signal Gate1(n), the n−1th stage second scan control signal Gate2(n−1) and the irradiance control signal EM are combined with one another, and correspond to a pre-charge stage, a program stage, a restore stage and a drive stage one after another. The irradiance control signal EM provides low voltage level in any of the pre-charge stage, the program stage and the restore stage to control the organic light emitting diode D1 not to emit light; and provides high voltage level in the drive stage to control the organic light emitting diode D1 to emit light.

Specifically, in the pre-charge stage, the irradiance control signal EM is low voltage level, the nth stage second scan control signal Gate2(n) is low voltage level, and the nth stage first scan control signal Gate1(n) is low voltage level, and the n−1th stage second scan control signal Gate2(n−1) is high voltage level; in the program stage, the irradiance control signal EM is low voltage level, the nth stage second scan control signal Gate2(n) is high voltage level, and the nth stage first scan control signal Gate1(n) is high voltage level, and the n−1th stage second scan control signal Gate2(n−1) is low voltage level; in the restore stage, the irradiance control signal EM is low voltage level, the nth stage second scan control signal Gate2(n) is high voltage level, and the nth stage first scan control signal Gate1(n) is low voltage level, and the n−1th stage second scan control signal Gate2(n−1) is low voltage level; in the drive stage, the irradiance control signal EM is high voltage level, the nth stage second scan control signal Gate2(n) is low voltage level, and the nth stage first scan control signal Gate1(n) is low voltage level, and the n−1th stage second scan control signal Gate2(n−1) is low voltage level. Furthermore, in the program stage, the data signal Data is high voltage level; in the restore stage, the data signal Data is low voltage level.

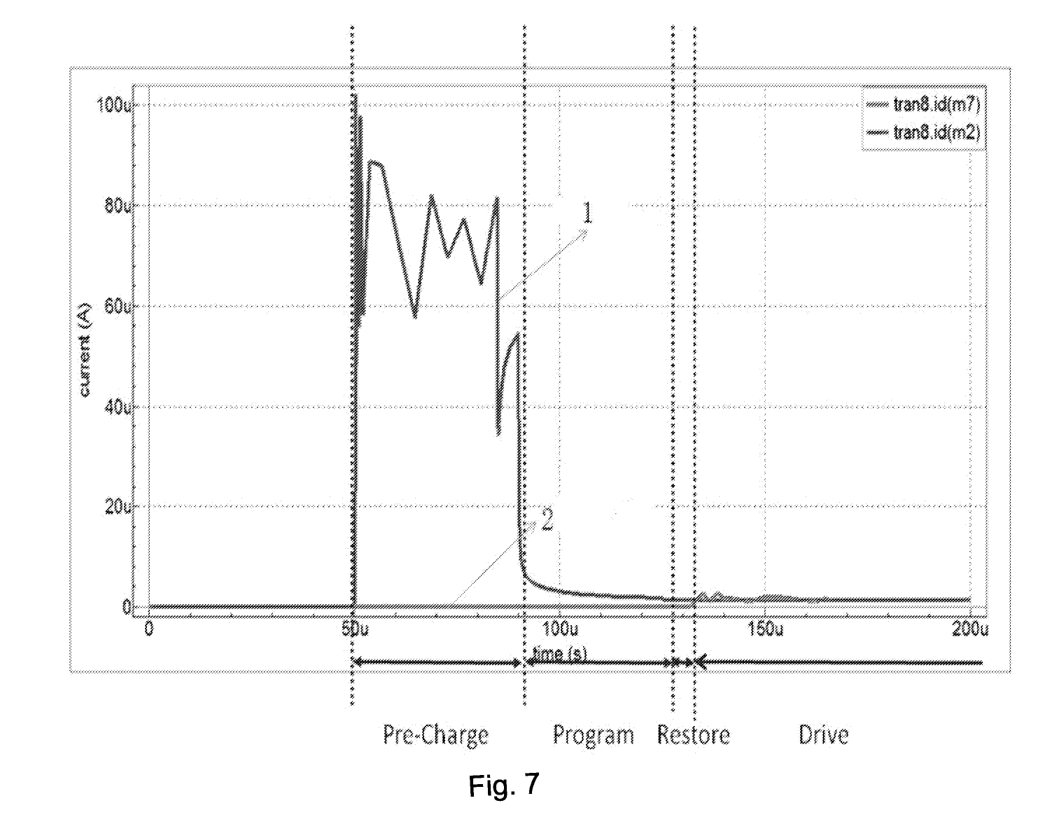

Compared with prior art, the irradiance control signal EM and the irradiance control thin film transistor, i.e. the second thin film transistor M2 controlled by the irradiance control signal EM are added in the aforesaid embodiment. The second thin film transistor M2 is located between the organic light emitting diode D1 and the direct current power supply voltage VDD. Only when the second thin film transistor M2 is activated, the organic light emitting diode D1 will be conducted with the direct current power supply voltage VDD to generate the current flowing through the organic light emitting diode D1 to drive the organic light emitting diode D1 to emit light. Because the irradiance control signal EM provides low voltage level in any of the pre-charge stage, the program stage and the restore stage, the second thin film transistor M2 is deactivated to interrupt the connection of the organic light emitting diode D1 and the direct current power supply voltage VDD, and the organic light emitting diode D1 does not emit light; the irradiance control signal EM provides high voltage level in drive stage, the second thin film transistor M2 is activated to conduct the organic light emitting diode D1 with the direct current power supply voltage VDD, and the organic light emitting diode D1 emits light. As shown in FIG. 6, in the pre-charge stage, the program stage and the restore stage, no current flows through the organic light emitting diode D1, and the organic light emitting diode D1 does not emit light; in the drive stage, the current normally flows through the organic light emitting diode D1 to drive the organic light emitting diode D1 to emit light. As shown in FIG. 7, being compared with the AMOLED pixel driving circuit provided according to prior art, the drive current flowing through the organic light emitting diode D1 is obviously diminished in the pre-charge stage, the program stage and the restore stage in the first embodiment of the present invention. In the drive stage, the two current are equal. Thus, the organic light emitting diode D1 stops emitting light in the irradiance unnecessary period. Thus, the issue that the unnecessary irradiance of the organic light emitting diode occurs during the process of compensating the drift of the threshold voltage of the drive thin film transistor in the AMOLED pixel driving circuit according to prior art can be solved to extend the lifetime of the OLED and optimize the actual display effect of the panel.

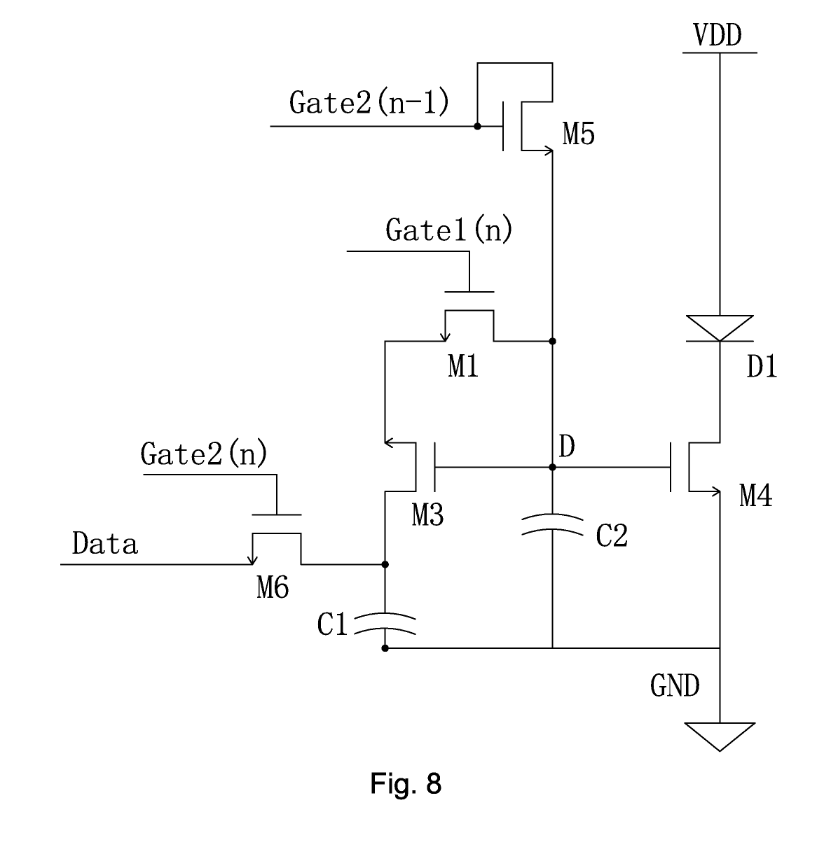

FIG. 8. shows the circuit diagram of the AMOLED pixel driving circuit according to the second embodiment of the present invention, comprising: a first thin film transistor M1, a third thin film transistor M3, a fourth thin film transistor M4, a fifth thin film transistor M5, a sixth thin film transistor M6, a first capacitor C1, a second capacitor C2 and an organic light emitting light diode D1. A gate of the sixth thin film transistor M6 is electrically coupled to an nth stage second scan control signal Gate2(n), and a source is electrically coupled to a data signal Data, and a drain is electrically coupled to a drain of the third thin film transistor M3 and one end of the first capacitor C1; a gate of the third thin film transistor M3 is electrically coupled to a gate of the fourth thin film transistor M4 via a first node D, and a source is electrically coupled to the source of the first thin film transistor M1, and the drain is electrically coupled to the drain of the sixth thin film transistor M6 and the one end of the first capacitor C1; a gate of the first thin film transistor M1 is electrically coupled to an nth stage first scan control signal Gate1(n), and the source is electrically coupled to the source of the third thin film transistor M3, and a drain is electrically coupled to the first node D; both a gate and a drain of the fifth thin film transistor M5 are electrically coupled to an n−1th stage second scan control signal Gate2(n−1), and a source is electrically coupled to the first node D; a gate of the fourth thin film transistor M4 is electrically coupled to a first node D, and a source is electrically coupled to an earth terminal GND, and a drain is electrically coupled to a cathode of the organic light emitting diode D1; the one end of the first capacitor C1 is electrically coupled to the drain of the sixth thin film transistor M6 and the drain of the third thin film transistor M3, and the other end is electrically coupled to the earth GND; one end of the second capacitor C2 is electrically coupled to the first node D, and the other end is electrically coupled to the earth GND; the anode of the organic light emitting diode D1 is electrically coupled to the alternating current power supply voltage VDD, and a cathode is electrically coupled to the drain of the fourth thin film transistor M4.

Specifically, all of the first thin film transistor M1, the third thin film transistor M3, the fourth thin film transistor M4, the fifth thin film transistor M5 and the sixth thin film transistor M6 are Low Temperature Poly-silicon thin film transistors, oxide semiconductor thin film transistors or amorphous silicon thin film transistors. The sixth thin film transistor M6 is a switch thin film transistor, and the third thin film transistor M3 is a mirror thin film transistor, and the fourth thin film transistor M4 is a drive thin film transistor, and the fifth thin film transistor M5 is a pre-charge thin film transistor.

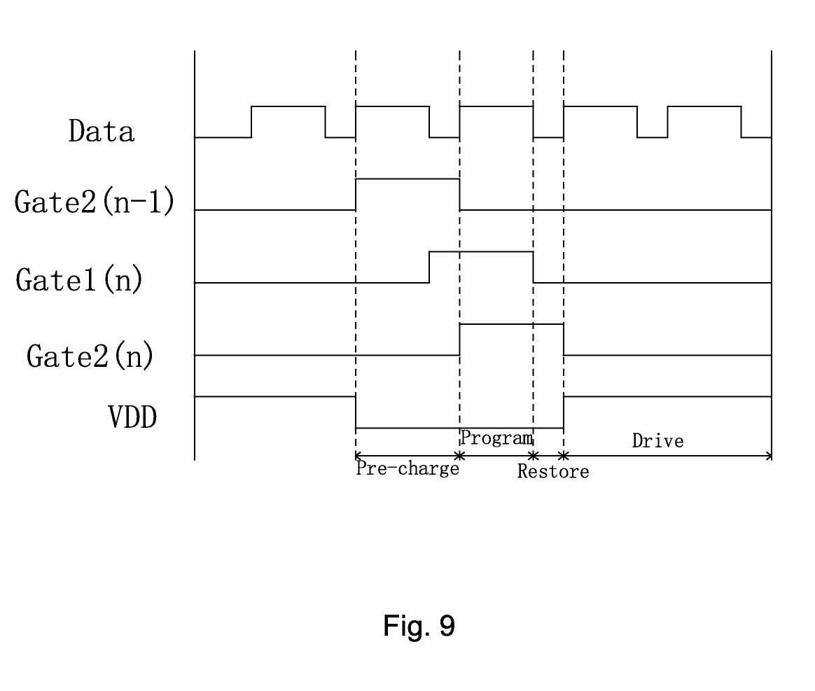

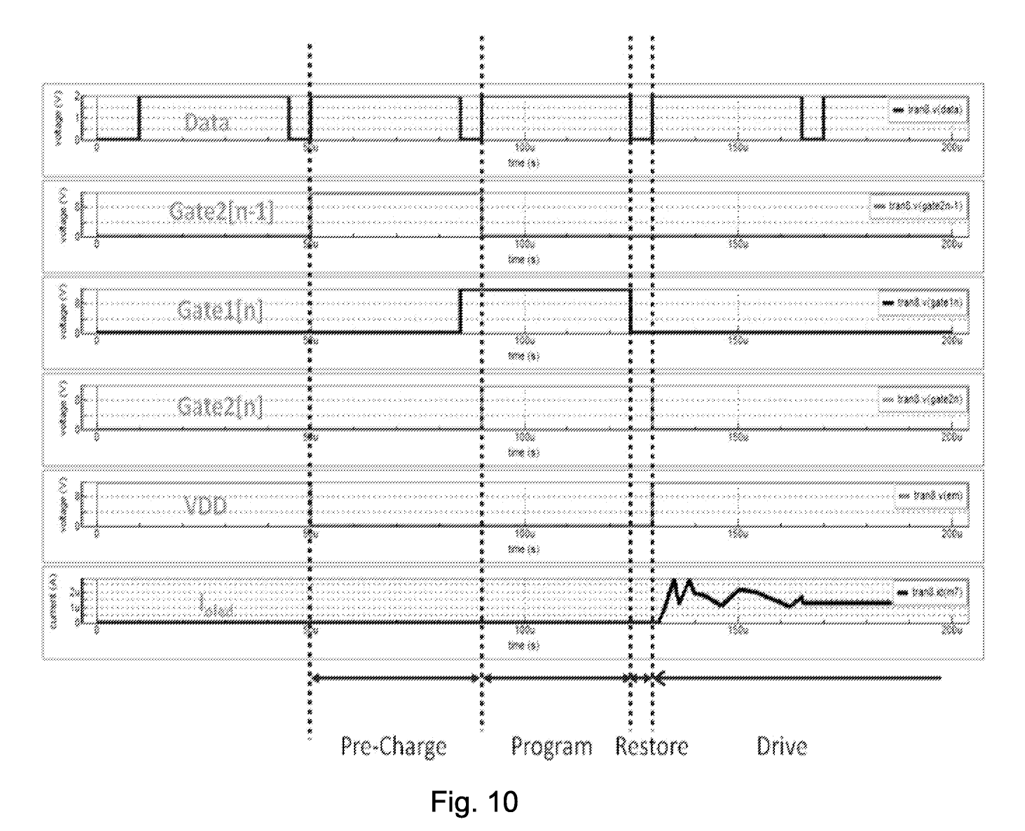

Specifically required for explanation: compared with the first embodiment, the second embodiment does not comprise the second thin film transistor M2, i.e. the irradiance control thin film transistor and the irradiance control signal EM but the alternating current power supply voltage provides high, low alternate voltages according to time sequence to control whether the organic light emitting diode D1 emits light or not and to simplify the circuit structure. Please refer to FIG. 8, FIG. 9, FIG. 10, together. In the second embodiment, the nth stage second scan control signal Gate2(n), the nth stage first scan control signal Gate1(n), the n−1th stage second scan control signal Gate2(n−1) and the alternating current power supply voltage VDD are combined with one another, and correspond to a pre-charge stage, a program stage, a restore stage and a drive stage one after another. The alternating current power supply voltage VDD provides low voltage level in any of the pre-charge stage, the program stage and the restore stage to control the organic light emitting diode D1 not to emit light; and provides high voltage level in the drive stage to control the organic light emitting diode D1 to emit light.

Specifically, in the pre-charge stage, the nth stage second scan control signal Gate2(n) is low voltage level, and the nth stage first scan control signal Gate1(n) is low voltage level, and the n−1th stage second scan control signal Gate2(n−1) is high voltage level; in the program stage, the nth stage second scan control signal Gate2(n) is high voltage level, and the nth stage first scan control signal Gate1(n) is high voltage level, and the n−1th stage second scan control signal Gate2(n−1) is low voltage level; in the restore stage, the nth stage second scan control signal Gate2(n) is high voltage level, and the nth stage first scan control signal Gate1(n) is low voltage level, and the n−1th stage second scan control signal Gate2(n−1) is low voltage level; in the drive stage, the nth stage second scan control signal Gate2(n) is low voltage level, and the nth stage first scan control signal Gate1(n) is low voltage level, and the n−1th stage second scan control signal Gate2(n−1) is low voltage level. Furthermore, in the program stage, the data signal Data is high voltage level; in the restore stage, the data signal Data is low voltage level.

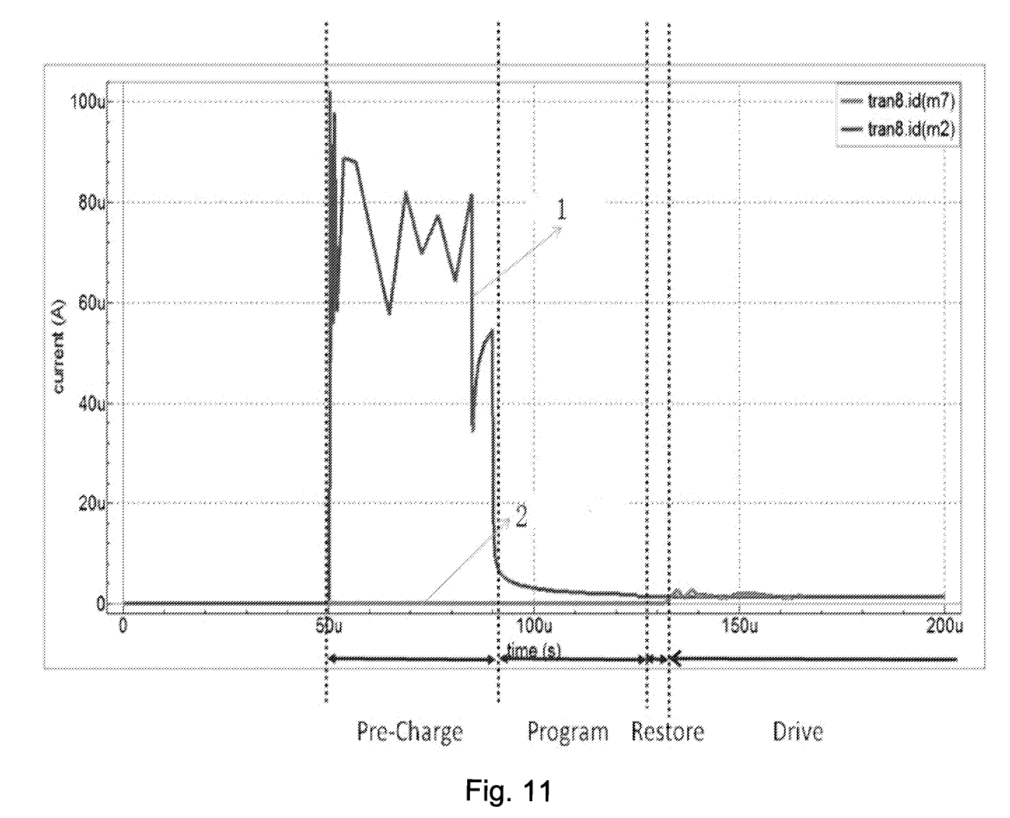

Comparing the second embodiment with prior art, the direct current power supply voltage is changed with the alternating current power supply voltage. Only when the alternating current power supply voltage VDD provides high voltage level, the current can be generated to drive the organic light emitting diode D1 to emit light. Because the alternating current power supply voltage VDD provides low voltage level in any of the pre-charge stage, the program stage and the restore stage, the organic light emitting diode D1 does not emit light; the alternating current power supply voltage VDD provides high voltage level in drive stage, the organic light emitting diode D1 emits light. As shown in FIG. 10, in the pre-charge stage, the program stage and the restore stage, no current flows through the organic light emitting diode D1, and the organic light emitting diode D1 does not emit light; in the drive stage, the current normally flows through the organic light emitting diode D1 to drive the organic light emitting diode D1 to emit light. As shown in FIG. 11, being compared with the AMOLED pixel driving circuit provided according to prior art, the drive current flowing through the organic light emitting diode D1 is obviously diminished in the pre-charge stage, the program stage and the restore stage in the first embodiment of the present invention. In the drive stage, the two current are equal. Thus, the organic light emitting diode D1 stops emitting light in the irradiance unnecessary period. Thus, the issue that the unnecessary irradiance of the organic light emitting diode occurs during the process of compensating the drift of the threshold voltage of the drive thin film transistor in the AMOLED pixel driving circuit according to prior art can be solved to extend the lifetime of the OLED and optimize the actual display effect of the panel.

In conclusion, the AMOLED pixel driving circuit provided by the present invention, by adding the thin film transistor controlled by the irradiance control signal between the organic light emitting diode and the direct current power supply voltage or by utilizing the alternating current power supply voltage to control whether the organic light emitting diode emits light or not to set the irradiance control signal or the alternating current power supply voltage to provide high voltage level only in the drive stage and to provide low voltage level in the rest stages, makes the OLED to be in off state in the irradiance unnecessary period and stops the OLED emitting light in the irradiance unnecessary period. Thus, the issue that the unnecessary irradiance of the organic light emitting diode occurs during the process of compensating the drift of the threshold voltage of the drive thin film transistor in the AMOLED pixel driving circuit according to prior art can be solved to extend the lifetime of the OLED and optimize the actual display effect of the panel.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. An AMOLED pixel driving circuit comprises: a first thin film transistor, a second thin film transistor, a third thin film transistor, a fourth thin film transistor, a fifth thin film transistor, a sixth thin film transistor, a first capacitor, a second capacitor and an organic light emitting diode;
a gate of the sixth thin film transistor is electrically coupled to an nth stage second scan control signal, and a source is electrically coupled to a data signal, and a drain is electrically coupled to a drain of the third thin film transistor and one end of the first capacitor;
a gate of the third thin film transistor is electrically coupled to a gate of the fourth thin film transistor via a first node, and a source is electrically coupled to the source of the first thin film transistor, and the drain is electrically coupled to the drain of the sixth thin film transistor and the one end of the first capacitor;
a gate of the first thin film transistor is electrically coupled to an nth stage first scan control signal, and the source is electrically coupled to the source of the third thin film transistor, and a drain is electrically coupled to the first node;
both a gate and a drain of the fifth thin film transistor are electrically coupled to an n−1th stage second scan control signal, and a source is electrically coupled to the first node;
a gate of the second thin film transistor is electrically coupled to an irradiance control signal, and a source is electrically coupled to a direct current power supply voltage, and a drain is electrically coupled to an anode of the organic light emitting diode;
a gate of the fourth thin film transistor is electrically coupled to a first node, and a source is electrically coupled to an earth, and a drain is electrically coupled to a cathode of the organic light emitting diode;
the one end of the first capacitor is electrically coupled to the drain of the sixth thin film transistor and the drain of the third thin film transistor, and the other end is electrically coupled to the earth;
one end of the second capacitor is electrically coupled to the first node, and the other end is electrically coupled to the earth;
the anode of the organic light emitting diode is electrically coupled to the drain of the second thin film transistor, and a cathode is electrically coupled to the drain of the fourth thin film transistor;
the direct current power supply voltage provides high voltage level;
the irradiance control signal provides high, low alternate voltages according to time sequence to control whether the organic light emitting diode emits light or not.

2. The AMOLED pixel driving circuit according to claim 1, wherein all of the first thin film transistor, the second thin film transistor, the third thin film transistor, the fourth thin film transistor, the fifth thin film transistor and the sixth thin film transistor are Low Temperature Poly-silicon thin film transistors, oxide semiconductor thin film transistors or amorphous silicon thin film transistors.

3. The AMOLED pixel driving circuit according to claim 1, wherein the nth stage second scan control signal, the nth stage first scan control signal, the n−1th stage second scan control signal and the irradiance control signal are combined with one another, and correspond to a pre-charge stage, a program stage, a restore stage and a drive stage one after another;
the irradiance control signal provides low voltage level in any of the pre-charge stage, the program stage and the restore stage to control the organic light emitting diode not to emit light; and provides high voltage level in the drive stage to control the organic light emitting diode to emit light.

4. The AMOLED pixel driving circuit according to claim 3, wherein,
in the pre-charge stage, the nth stage second scan control signal is low voltage level, and the nth stage first scan control signal is low voltage level, and the n−1th stage second scan control signal is high voltage level;
in the program stage, the nth stage second scan control signal is high voltage level, and the nth stage first scan control signal is high voltage level, and the n−1th stage second scan control signal is low voltage level;
in the reset stage, the nth stage second scan control signal is high voltage level, and the nth stage first scan control signal is low voltage level, and the n−1th stage second scan control signal is low voltage level;
in the drive stage, the nth stage second scan control signal is low voltage level, and the nth stage first scan control signal is low voltage level, and the n−1th stage second scan control signal is low voltage level.

5. The AMOLED pixel driving circuit according to claim 4, wherein in the program stage, the data signal is high voltage level; in the restore stage, the data signal is low voltage level.

6. An AMOLED pixel driving circuit comprises: a first thin film transistor, a third thin film transistor, a fourth thin film transistor, a fifth thin film transistor, a sixth thin film transistor, a first capacitor, a second capacitor and an organic light emitting diode;
a gate of the sixth thin film transistor is electrically coupled to an nth stage second scan control signal, and a source is electrically coupled to a data signal, and a drain is electrically coupled to a drain of the third thin film transistor and one end of the first capacitor;
a gate of the third thin film transistor is electrically coupled to a gate of the fourth thin film transistor via a first node, and a source is electrically coupled to the source of the first thin film transistor, and the drain is electrically coupled to the drain of the sixth thin film transistor and the one end of the first capacitor;
a gate of the first thin film transistor is electrically coupled to an nth stage first scan control signal, and the source is electrically coupled to the source of the third thin film transistor, and a drain is electrically coupled to the first node;
both a gate and a drain of the fifth thin film transistor are electrically coupled to an n−1th stage second scan control signal, and a source is electrically coupled to the first node;
a gate of the fourth thin film transistor is electrically coupled to a first node, and a source is electrically coupled to an earth, and a drain is electrically coupled to a cathode of the organic light emitting diode;
the one end of the first capacitor is electrically coupled to the drain of the sixth thin film transistor and the drain of the third thin film transistor, and the other end is electrically coupled to the earth;
one end of the second capacitor is electrically coupled to the first node, and the other end is electrically coupled to the earth;
the anode of the organic light emitting diode is electrically coupled to an alternating current power supply voltage, and a cathode is electrically coupled to the drain of the fourth thin film transistor;
the alternating current power supply voltage provides high, low alternate voltages according to time sequence to control whether the organic light emitting diode emits light or not.

7. The AMOLED pixel driving circuit according to claim 6, wherein all of the first thin film transistor, the third thin film transistor, the fourth thin film transistor, the fifth thin film transistor and the sixth thin film transistor are Low Temperature Poly-silicon thin film transistors, oxide semiconductor thin film transistors or amorphous silicon thin film transistors.

8. The AMOLED pixel driving circuit according to claim 6, wherein the nth stage second scan control signal, the nth stage first scan control signal, the n−1th stage second scan control signal and the alternating current power supply voltage are combined with one another, and correspond to a pre-charge stage, a program stage, a restore stage and a drive stage one after another;
the alternating current power supply voltage provides low voltage level in any of the pre-charge stage, the program stage and the restore stage to control the organic light emitting diode not to emit light; and provides high voltage level in the drive stage to control the organic light emitting diode to emit light.

9. The AMOLED pixel driving circuit according to claim 8, wherein,
in the pre-charge stage, the nth stage second scan control signal is low voltage level, and the nth stage first scan control signal is low voltage level, and the n−1th stage second scan control signal is high voltage level;
in the program stage, the nth stage second scan control signal is high voltage level, and the nth stage first scan control signal is high voltage level, and the n−1th stage second scan control signal is low voltage level;
in the reset stage, the nth stage second scan control signal is high voltage level, and the nth stage first scan control signal is low voltage level, and the n−1th stage second scan control signal is low voltage level;
in the drive stage, the nth stage second scan control signal is low voltage level, and the nth stage first scan control signal is low voltage level, and the n−1th stage second scan control signal is low voltage level.

10. The AMOLED pixel driving circuit according to claim 9, wherein in the program stage, the data signal is high voltage level; in the reset stage, the data signal is low voltage level.

11. An AMOLED pixel driving circuit comprises: a first thin film transistor, a third thin film transistor, a fourth thin film transistor, a fifth thin film transistor, a sixth thin film transistor, a first capacitor, a second capacitor and an organic light emitting diode;
a gate of the sixth thin film transistor is electrically coupled to an nth stage second scan control signal, and a source is electrically coupled to a data signal, and a drain is electrically coupled to a drain of the third thin film transistor and one end of the first capacitor;
a gate of the third thin film transistor is electrically coupled to a gate of the fourth thin film transistor via a first node, and a source is electrically coupled to the source of the first thin film transistor, and the drain is electrically coupled to the drain of the sixth thin film transistor and the one end of the first capacitor;
a gate of the first thin film transistor is electrically coupled to an nth stage first scan control signal, and the source is electrically coupled to the source of the third thin film transistor, and a drain is electrically coupled to the first node;
both a gate and a drain of the fifth thin film transistor are electrically coupled to an n−1th stage second scan control signal, and a source is electrically coupled to the first node;
a gate of the fourth thin film transistor is electrically coupled to a first node, and a source is electrically coupled to an earth, and a drain is electrically coupled to a cathode of the organic light emitting diode;
the one end of the first capacitor is electrically coupled to the drain of the sixth thin film transistor and the drain of the third thin film transistor, and the other end is electrically coupled to the earth;
one end of the second capacitor is electrically coupled to the first node, and the other end is electrically coupled to the earth;
the anode of the organic light emitting diode is electrically coupled to an alternating current power supply voltage, and a cathode is electrically coupled to the drain of the fourth thin film transistor;
the alternating current power supply voltage provides high, low alternate voltages according to time sequence to control whether the organic light emitting diode emits light or not;
wherein all of the first thin film transistor, the third thin film transistor, the fourth thin film transistor, the fifth thin film transistor and the sixth thin film transistor are Low Temperature Poly-silicon thin film transistors, oxide semiconductor thin film transistors or amorphous silicon thin film transistors.
wherein the nth stage second scan control signal, the nth stage first scan control signal, the n−1th stage second scan control signal and the alternating current power supply voltage are combined with one another, and correspond to a pre-charge stage, a program stage, a restore stage and a drive stage one after another;
the alternating current power supply voltage provides low voltage level in any of the pre-charge stage, the program stage and the restore stage to control the organic light emitting diode not to emit light; and provides high voltage level in the drive stage to control the organic light emitting diode to emit light.

12. The AMOLED pixel driving circuit according to claim 11, wherein,
in the pre-charge stage, the nth stage second scan control signal is low voltage level, and the nth stage first scan control signal is low voltage level, and the n−1th stage second scan control signal is high voltage level;
in the program stage, the nth stage second scan control signal is high voltage level, and the nth stage first scan control signal is high voltage level, and the n−1th stage second scan control signal is low voltage level;
in the reset stage, the nth stage second scan control signal is high voltage level, and the nth stage first scan control signal is low voltage level, and the n−1th stage second scan control signal is low voltage level;
in the drive stage, the nth stage second scan control signal is low voltage level, and the nth stage first scan control signal is low voltage level, and the n−1th stage second scan control signal is low voltage level.

13. The AMOLED pixel driving circuit according to claim 12, wherein in the program stage, the data signal is high voltage level; in the restore stage, the data signal is low voltage level.
